(19) United States
(12) Patent Application Publication
(10) Pub. No.: US 2013/0102299 A1
(43) Pub. Date: Apr. 25, 2013

(54) System and Method for Supporting Multiple Phone System

(71) Applicants: Wen-Hsiang Liu, Taoyuan County (TW); Chun-Yu Lai, Taoyuan County (TW); Guai-Ting Wu, Taoyuan County (TW)

(72) Inventors: Wen-Hsiang Liu, Taoyuan County (TW); Chun-Yu Lai, Taoyuan County (TW); Guai-Ting Wu, Taoyuan County (TW)

(21) Appl. No.: 13/607,841

(22) Filed: Sep. 10, 2012

Related U.S. Application Data
(60) Provisional application No. 61/549,203, filed on Oct. 19, 2011.

(51) Int. Cl. H04W 88/06; H04W 48/18

(52) U.S. Cl. 455/418; 455/552.1

(57) ABSTRACT

The present invention provides a method for supporting multiple communication systems in a mobile communication device. The method includes providing at least two communication channels, each communication channel comprising a communication module; receiving a communication request; directing the communication request to a selected communication channel among the at least two communication channels according to a communication type information; and transmitting data associated with the communication request through the selected communication channel. Wherein each communication module of the at least two communication channels supports different transmission protocol.

### CROSS REFERENCE TO RELATED APPLICATIONS

This application claims priority of U.S. Provisional No. 61/549,203 filed on Oct. 19, 2011.

### BACKGROUND OF THE INVENTION

1. Field of the Invention

The present invention relates to phone systems, and particularly to systems and methods for supporting multiple phone systems.

2. Description of the Prior Art

Mobile communication device typically feature high-end mobile processors and a large touch screen, such as smartphone, PDA, tablet, etc. Most mobile communication device users purchase a data plan in addition to a mobile phone plan in order to access content on the Internet through a browser or through various applications (apps) that can be installed on the mobile communication device. Numerous operating systems (OS) have been developed for use with mobile communication devices, including Android, iOS, Windows Mobile, and/or others.

Typically, these operating systems provide single-standby telephony architecture. Only one communication system is enabled at a time to provide communication functionality. If another communication system needs to be used, the original communication system is terminated by selecting a desired communication mode configuration. Communication system performance however depends on desired signal strength. The applications/services that require communication service may suffer from delay or cannot be executed properly if the communication system keeps searching for service in a poor signal area. As a result, it may be preferred to switch the current communication system to another with better communication quality. During the communication system switch, both communication systems may have no access temporarily, so that phone calls can not be dialed or received, and browsing and sending/receiving of MMS (Multimedia Message Service) can not be performed. If the mobile communication device switches communication system at often, this impacts the user experience seriously.

Among these operating systems, Android is developed by the Open Handset Alliance led by Google. FIG. 1 illustrates an embodiment of communication architecture of Android OS. An Android communication system 10 includes applications 100, an application framework 110, libraries 120, a kernel 130, and a baseband layer 140. The applications 100 may include phone application. The application framework 110 may include telephony and radio interface layer (RIL). The libraries 120 may include an RIL Daemon (RILD) and a vendor RIL. The baseband layer 140 may include a modem. As can be seen from FIG. 1, the communication architecture can only support one communication system in the application framework layer, as well as the radio interface layer (RIL). Therefore, in order to support multiple communication systems, the mobile device requires two separate sets of the same architecture as shown in FIG. 1 which might increase cost and processing complexity. Therefore, there exists a need for multiple-mode multiple-standby communication systems for use in a mobile communication device.

### SUMMARY OF THE INVENTION

The present invention provides a method for supporting multiple communication systems in a mobile communication device. The method comprises providing at least two communication channels, each communication channel comprising a communication module; receiving a communication request; directing the communication request to a selected communication channel among the at least two communication channels according to a communication type information; and transmitting data associated with the communication request through the selected communication channel. Wherein each communication module of the at least two communication channels supports different transmission protocol.

The present invention further provides a mobile communication apparatus. The mobile communication apparatus comprises a first communication system for providing a first communication channel; a second communication system for providing a second communication channel; an interface unit, configured to receive an input for initiating a communication access; and a processing unit, configured to process the communication access through the first communication channel or the second communication channel according to the received input.

The present invention further provides a method for supporting multiple communication systems. The method comprises setting one of a plurality communication channels as a preferred communication channel; establishing a transmission request; attaching an identifier to the transmission request; determining whether the identifier attached to the transmission request corresponds to the preferred communication channel; and in response to the identifier corresponds to the preferred communication channel, performing transmission through the preferred communication channel according to the transmission request.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an Android communication system architecture.

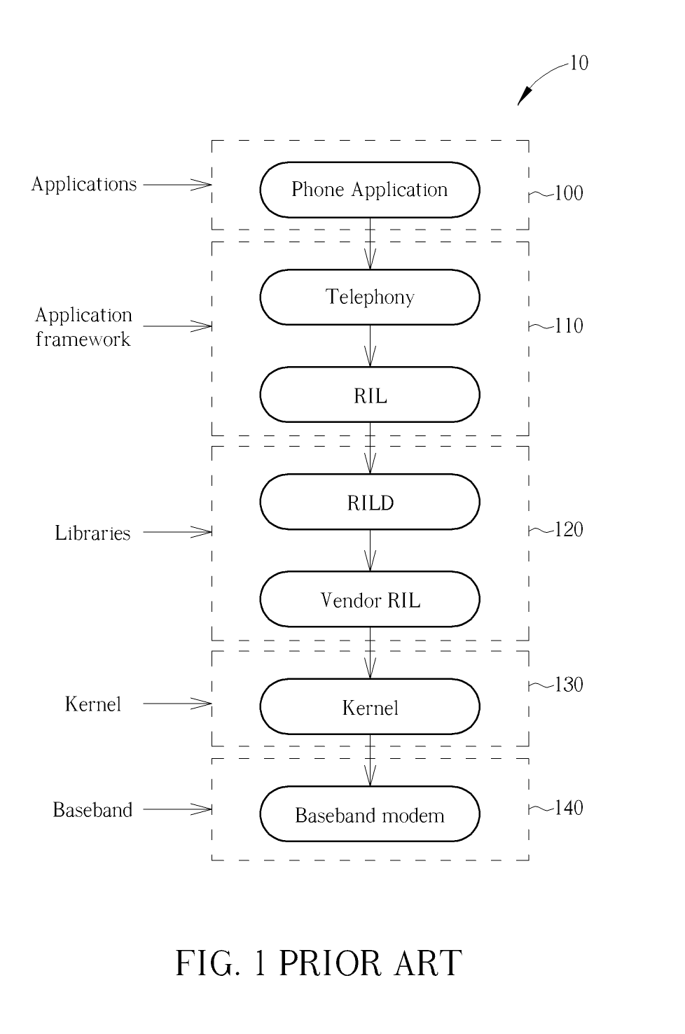

FIG. 2 is a diagram showing a mobile communication device of the present invention.

FIG. 3 is a diagram illustrating a dual-mode dual-standby communication system architecture of the present invention.

FIG. 4 is a diagram illustrating an interface for selecting the communication channel.

FIG. 5 is a diagram illustrating another interface for selecting the communication channel.

FIG. 6 is a flowchart showing a method for supporting multiple phone systems in a mobile communication device of the present invention.

FIG. 7 is a flowchart showing another method for supporting multiple phone systems in a mobile communication device of the present invention.

### DETAILED DESCRIPTION

Generally, when supporting multiple phone systems in a mobile communication device, data transmission charge and power consumption may be increased due to the multiple phone systems both have different fee plan and require separate power supply. The data transmission charge may be increased since data transmission services provided by the multiple phone systems are charged respectively. Besides, since the connections of the multiple phone systems are implemented by multiple hardware circuits/units, the power consumption is increased.

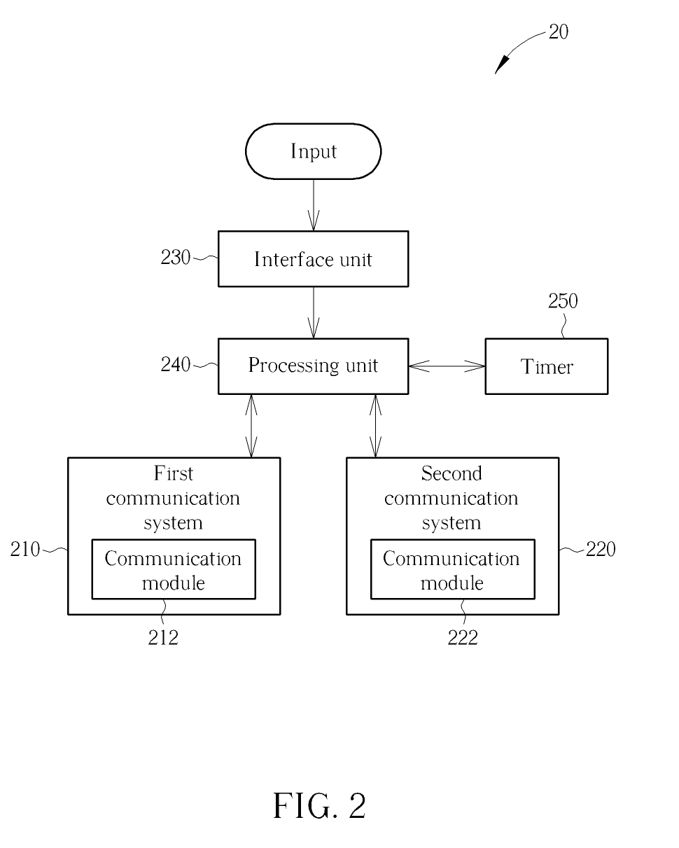

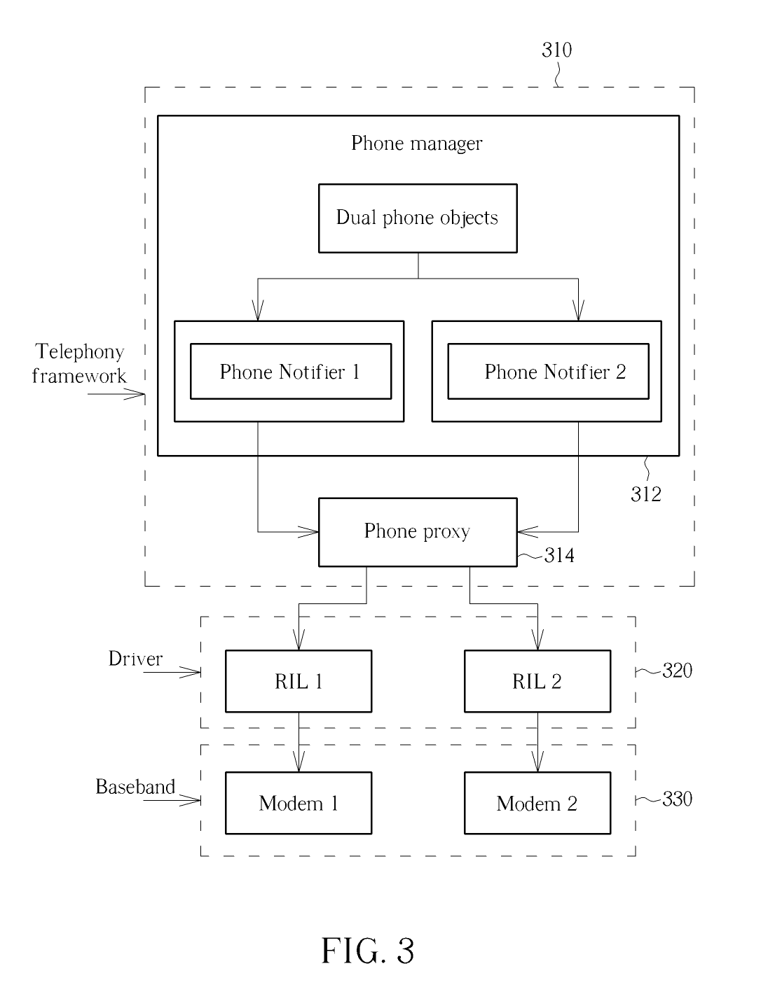

In order to save the data transmission charge and power consumption, the present invention provides a method and a mobile communication device capable of supporting multiple phone systems. Please refer to FIG. 2 and FIG. 3. FIG. 2 is a diagram showing a mobile communication device of the present invention. FIG. 3 is a diagram illustrating multiple-mode multiple-standby communication system architecture of the present invention. The multiple-mode multiple-standby communication system architecture can be implemented into the mobile communication device of the present invention for supporting multiple phone systems. As shown in FIG. 2, the mobile communication device 20 comprises a first phone system 210, a second phone system 220, an interface unit 230, and a processing unit 240. The first phone system 210 is for providing a first communication channel. The second phone system 220 is for providing a second communication channel. Each of the communication channels comprises a communication module 212, 222 (such as a baseband chip), and the communication modules 212, 222 of the two communication channels support different transmission protocols (such as CDMA and GSM protocols). The interface unit 230 is configured to receive an input for initiating a communication. For example, the interface unit 230 can receive a touch input from a touch screen and initiate a data communication for uploading data according to the touch input. The processing unit 240 is configured to process the communication through the first communication channel or the second communication channel according to the received input.

As shown in FIG. 3, in order to support multiple phone systems, two phone objects corresponding to the two communication modules 212, 222 are built and registered to a phone manager 310 within the telephony framework 310. During creation of the phone objects, two sets of phone notifiers PhoneNotifier1, PhoneNotifier2 are generated with respect to each communication module 212, 222. The output of the phone manager 312 is fed to the input of a phone proxy 314 within the telephony framework 310. The phone proxy 314 brings out two different RIL daemons to connect with two RIL drivers RIL1, RIL2. The two RIL drivers RIL1, RIL2 are connected to two different modems Modem1, Modem2 of the communication modules 212, 222 respectively. In the above arrangement, requests, responses and indications could be sent or received simultaneously via the two different communication modules 212, 222.

When the interface unit 230 receives an input to set one of the communication channels as a preferred communication channel, the processing unit 240 enables the phone system providing the selected communication channel for various transmissions (such as voice call, multimedia call, text message, multimedia message, internet connection and data upload/download), and disables the other phone system. Thereafter, when a user tries to initiate a transmission through the interface unit 230, a transmission request is established and an identifier is attached to the transmission request within the telephony framework 310. The identifier attached to the transmission request corresponds to communication type information (e.g. CDMA or GSM) of the phone system. The phone proxy 314 then checks whether the identifier attached to the transmission request corresponds to any of the communication channels. If the identifier corresponds to one of the communications channel, the phone proxy 314 directs the transmission request to the selected communication channel, for performing transmission through the selected communication channel according to the transmission request.

In the above embodiment, there are different ways to set the preferred communication channel. For example, the preferred communication channel can be predefined through the interface unit 230; the preferred communication channel can be set by the user when initiating the communication; or the preferred communication channel can be determined according to signal strength of the communication modules.

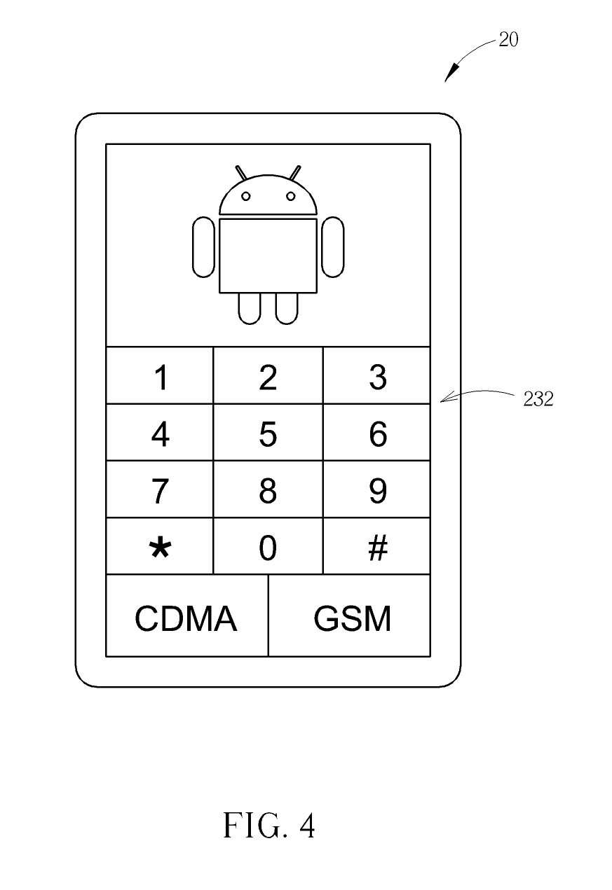

Please refer to FIG. 4, and refer to FIG. 2 and FIG. 3 as well. FIG. 4 is a diagram illustrating an interface for selecting the communication channel. As shown in FIG. 4, the interface unit 230 can provide an interface 232 displaying selectable options corresponding to the first phone system (such as CDMA) and the second phone system (such as GSM) when initiating the communication access. The user can directly select the preferred transmission channel to make a call or perform other communication operation.

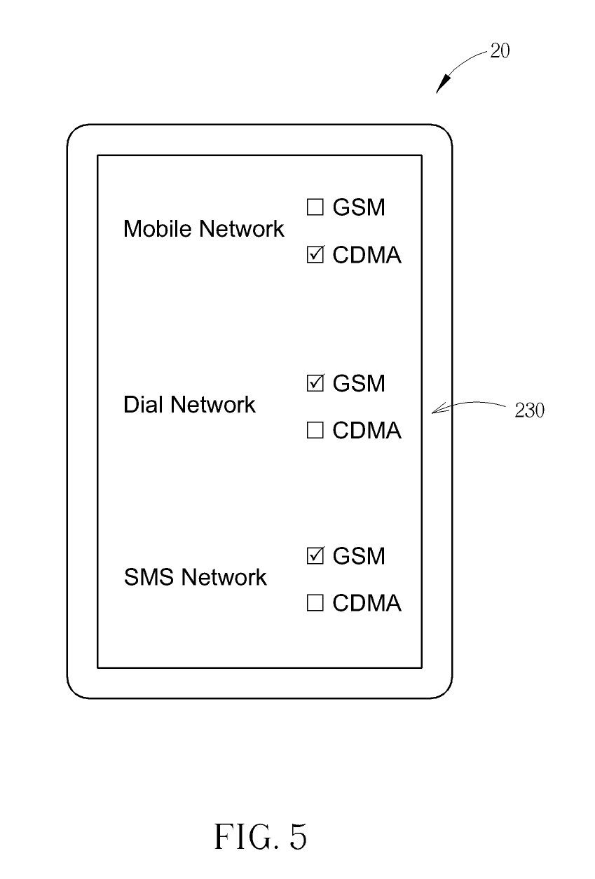

In addition, different kind of transmission activities can be conducted through different communication channels. For example, as shown in FIG. 5, the user can respectively predefined the preferred communication channels for the transmission activities of voice call, multimedia message service (MMS), and Internet connection. When the preferred communication channel of Internet connection (Mobile Network) is different from the preferred communication channel of voice call (Dial Network) or multimedia message service (SMS Network), the processing unit 240 can constantly enable the preferred communication channel of Internet connection, and temporarily disable the preferred communication channel for voice call or multimedia message service. In this way, the mobile communication device 20 can transmit data through the communication channel with lower data transmission fee, and the user will not be charged for unnecessary transmission through the unselected communication channel. When the user tries to make a voice call or send a multimedia message, the preferred communication channel of voice call or multimedia message service can be enabled shortly and then be disabled again when the voice call is ended or the multimedia message is sent.

Please refer to FIG. 2 again, the mobile communication device 20 can further comprise a timer 250 for counting a predetermined time from the preferred communication channel of voice call or multimedia message service is enabled. And the processing unit then disables the preferred communication channel of voice call or multimedia message service upon the timer 250 is expired.

According to the above arrangement, the transmission charge through the mobile network can be reduced, and the dial network or the MMS network can be flexibly enabled and disabled for further decreasing power consumption.

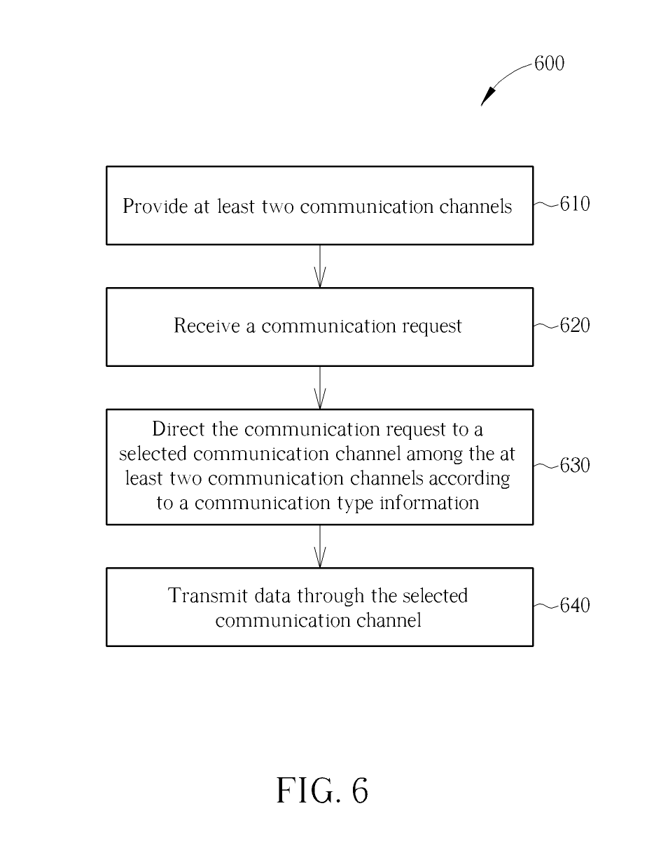

Please refer to FIG. 6. FIG. 6 is a flowchart 600 showing a method for supporting multiple phone systems in a mobile communication device of the present invention. The flowchart 600 comprises the following steps:

Step 610: Provide at least two communication channels, wherein each communication channel comprises a communication module;

Step 620: Receive a communication request;

Step 630: Direct the communication request to a selected communication channel among the at least two communication channels according to a communication type information; and

Step 640: Transmit data through the selected communication channel.

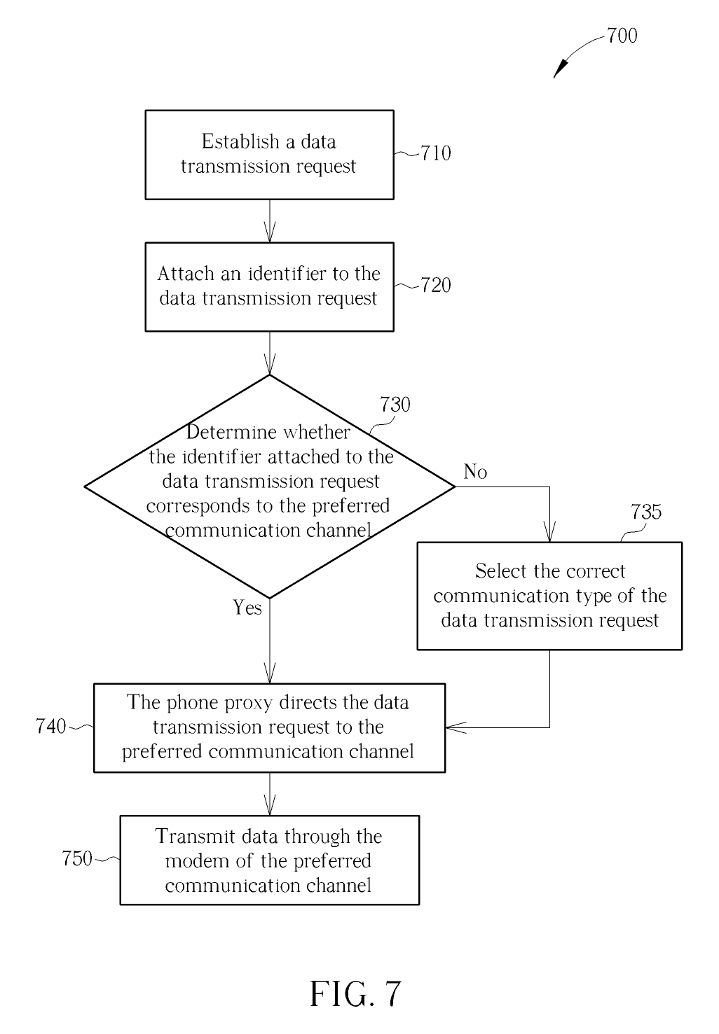

Please refer to FIG. 7. FIG. 7 is a flowchart 700 showing another method for supporting multiple phone systems in a mobile communication device of the present invention. The flowchart 700 comprises the following steps:

Step 710: Establish a transmission request;

Step 720: Attach an identifier to the transmission request;

Step 730: Determine whether the identifier attached to the transmission request corresponds to the preferred communication channel; if yes, go to step 740; if not, go to step 735;

Step 735: Select the correct communication type of the data transmission request;

Step 740: The phone proxy directs the transmission request to the preferred communication channel; and

Step 750: Transmit data through the modem of the preferred communication channel.

Basically, to achieve the same result, the steps of the flowcharts 600, 700 need not be in the exact order shown and need not be contiguous, that is, other steps can be intermediate.

In contrast to the prior art, the present invention provides a method for supporting multiple phone systems in a mobile communication device. The method and the mobile communication device of the present invention can constantly enable the selected communication channel and flexibly disable the unselected communication channel, so as to reduce the data transmission charge as well as the power consumption.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for supporting multiple communication systems in a mobile communication device, comprising:
providing at least two communication channels, each communication channel comprising a communication module;
receiving a communication request;
directing the communication request to a selected communication channel among the at least two communication channels according to a communication type information; and
transmitting data associated with the communication request through the selected communication channel;
wherein each communication module of the at least two communication channels supports different transmission protocol.

2. The method of claim 1, further comprising:
providing an interface for receiving an input to set the selected communication channel.

3. The method of claim 1, wherein the communication type information is an identifier attached to the communication request.

4. The method of claim 1, further comprising enabling the communication module of the selected communication channel.

5. The method of claim 4, further comprising:
disabling the communication module of the other communication channel.

6. The method of claim 4, further comprising:
disabling the communication module of the selected communication channel in response to a timer is expired or completion of the request.

7. The method of claim 1, wherein the communication type information is determined according to one of the following: a predefined setting, a user selection, signal strength corresponding to the communication module.

8. The method of claim 7, further comprising:
providing a user interface for receiving input corresponding to the user selection.

9. A mobile communication apparatus, comprising:
a first communication system for providing a first communication channel;
a second communication system for providing a second communication channel;
an interface unit, configured to receive an input for initiating a communication; and
a processing unit, configured to process the communication through the first communication channel or the second communication channel according to the received input.

10. The mobile communication apparatus of claim 9, wherein the interface unit is further configured to receive settings of preferred communication channel corresponding to a plurality of transmissions respectively; the plurality of transmissions comprise at least voice call, multimedia call, text message, multimedia message, internet connection and data download.

11. The mobile communication apparatus of claim 9, wherein the interface unit is further configured to provide select options corresponding to the first communication system and the second communication system when initiating the communication.

12. The mobile communication apparatus of claim 11, wherein the processing unit is further configured to receive a request corresponding to the communication, the request comprises an identifier identifying the selected phone system.

13. The mobile communication apparatus of claim 9, wherein the processing unit is further configured to enable the communication system the communication is processed through, and disable the other communication system.

14. The mobile communication apparatus of claim 13, further comprising a timer for counting a predetermined time from the communication system is enabled, and the processing unit is further configured to disable the enabled communication system upon the timer is expired.

15. The mobile communication apparatus of claim 13, wherein the enabled communication system is disabled upon completion of the communication.

16. The mobile communication apparatus of claim 9, wherein the first communication channel comprises a first baseband chip, and the second communication channel comprises a second baseband chip.

17. A method for supporting multiple phone systems, comprising:
setting at least one of a plurality communication channels as a preferred communication channel;
establishing a transmission request;
attaching an identifier to the transmission request;
determining whether the identifier attached to the transmission request corresponds to the preferred communication channel; and
in response to the identifier corresponding to the preferred communication channel, performing transmission through the preferred communication channel according to the transmission request.

18. The method of claim 17, further comprising:
in response to the identifier not corresponding to the preferred communication channel, terminating the transmission request.

19. The method of claim 17, further comprising:
directing the transmission request to the preferred communication channel according to the identifier.

20. The method of claim 17, further comprising:
disabling other communication channels of the plurality communication channels.
